(19) United States
(12) Patent Application Publication
(10) Pub. No.: US 2010/0100929 A1
(43) Pub. Date: Apr. 22, 2010

(54) APPARATUS AND METHOD FOR SECURITY MANAGING OF INFORMATION TERMINAL

(75) Inventors: Guntae BAE, Daejeon (KR); Gaeil AN, Daejeon (KR); Minho HAN, Daejeon (KR); Kiyoung KIM, Daejeon (KR)

Correspondence Address: LAHIVE & COCKFIELD, LLP;FLOOR 30, SUITE 3000, ONE POST OFFICE SQUARE, BOSTON, MA, 02109, US

(73) Assignee: Electronics and Telecommunications Reasearch Institute, Daejeon (KR)

(21) Appl. No.: 12/571,873

(22) Filed: Oct. 1, 2009

(30) Foreign Application Priority Data
Oct. 20, 2008 (KR) 10-2008-0102647

(51) Int. Cl. G06F 17/00; H04L 9/32

(52) U.S. Cl. 726/1; 726/2

(57) ABSTRACT

Provided is an apparatus and a method for security managing of an information terminal. The provided classifies a plurality of information providing means into a plurality of domains including at least one information providing means and when a user process accesses any one domain and then attempts to access another domain, controls the access to said another domain by verifying whether or not the access of the user process to said another domain is allowed. According to the provided, security threats are monitored for each domain which an execution process accesses by simply constructing domain classification information of an entire system without specifically establishing a security policy of an information providing device, such that it is possible to protect a terminal from a multi-domain access process having high security risk. Accordingly, it is advantageous to increase security for the terminal from various security threats.

### RELATED APPLICATIONS

The present application claims priority to Korean Patent Application Serial Number 10-2008-0102647, filed on Oct. 20, 2008, the entirety of which is hereby incorporated by reference.

### BACKGROUND OF THE INVENTION

1. Field of the Invention

The present invention relates to an apparatus and a method for security managing of an information terminal, and more particularly, to an apparatus and a method for security managing of an information terminal that can implement an access control function for protecting the information terminal from a security risk.

2. Description of the Related Art

Recently, as information processing terminals include various types such as a PC, a notebook, a UMPC, a portable game machine, a PDA, a PMP, a smart phone, a wibro terminal, a telematics terminal, etc. and are minimized and composited, important information is leaked to the outside or availability of a terminal is damaged due to attacks of theft, service rejection, etc., and the terminal is infected with virus, malicious codes such the Trojan horse, etc. As described above, numerous security threats are increased. The terminals have convenient portability and high mobility and use a plurality of interfaces at the same time by adding a communication environment that includes Bluetooth, USB, WLAN, wifi, wibro, infrared, etc. to a general wired communication network. Further, even though a single personal user uses the terminals, the user may drive various services or applications, such that security threats are gradually increased.

An access control method used in the general information terminal includes a discretionary access control (hereinafter, referred to as ‘DAC’) and a mandatory access control (hereinafter, referred to as ‘MAC’).

First, the DAC is primarily used in UNIX and LINUX-based operating systems and controls access to an object on the basis of an object owner. That is, permission for a user, a group, etc. is allocated to each object to determine access to the corresponding object in accordance with the rule and an establishment right of the rule also belongs to the object owner. However, in the DAC, since all programs executed by the user have the same authority as the user, precision of a security level is very low. For example, when the user unconsciously executes a malicious code, a process including the code has the same authority as the user, such that the user cannot avoid infringement. In particular, in a lot of systems, access control is performed based on two user authorities of administer and normal user or the access control is always performed based on the administrator in order to maximize user convenience in an extreme case. In this case, security cannot be ensured. The DAC is an access control scheme suitable to make each user's authority for various resources (objects) such as a file, etc. clear when a plurality of users access one system at the same time. Therefore, the DAC is not equal to protect various terminals that must maintain the security.

Meanwhile, one of the MAC schemes that is applied to solve the above-mentioned problem is a multi-level security (hereinafter, referred to as ‘MLS’). The MLS has a disadvantage of being not suitable for a general use due to a special property to establish confidentiality of the object and authority of a subject one by one. In particular, the MLS is a scheme historically designed to meet access control policy requirements of a government or a military organization and has many problems in being basically used as a security technology for protecting general terminals.

Therefore, SELinux (Security Enhanced Linux) that is implemented by Linux is used as a method for solving the problems in the DAC and MLS schemes. In the SELinux, a security policy logic is clearly discriminated from an application module. The reason for this is to flexibly support various security policies. Generally proposed models such as type enforcement, role-based access control, multi-level security, etc. can be variously selected as access control models which can be applied to the security policy logic. The access control models adopt a scheme to construct a static policy with respect to a relationship of how to allow the subjects such as the user, the process, etc. to access the information object such as the file, etc. and enforce access control judgment on the basis of the policy. By this configuration, when a policy establishment suitable for an access control model which the user desires is normally constructed, an object protected by the establishment can be normally protected from a security threat situation.

The SELinux is very important as a generalized design for providing various security functions without omission, but the resultant establishment complexity serves as a large disadvantage in actual use. That is, it is very complicated to express a policy which must be pre-established for performing the access control and when a policy for subjects and objects to be protected by the subjects is not minutely pre-established, access control protection cannot be completely established. Further, a normal operation is limited due to default establishment of the SELinux, such that user convenience is remarkably deteriorated. Therefore, Linux is often used by disabling the function of the SELinux. That is, an administrator (security user) takes over complicated detailed establishments due to an excessively generalized design, which supports a variety of security establishments and as a result, it is very difficult to utilize the establishments to suit individual specific security situations that are changed in real time.

### SUMMARY OF THE INVENTION

An object of the present invention is to provide an apparatus and a method for security managing of an information terminal that allows a user to automatically protect the information terminal from a security threat situation without reflecting and constructing security requirements on a static security policy one by one.

In order to achieve the above-mentioned object, an apparatus for security managing of an information terminal, which has a plurality of information providing means according to an embodiment of the present invention includes a security management unit that classifies the plurality of information providing means into domains including at least one information providing means and generates a security policy for each of the classified domains and an access control unit that when a user process accesses any one domain and then attempts to access another domain, controls the access of said another domain by verifying whether or not the access of the user process to said another domain in accordance with a security policy generated by the security management unit.

Further, the apparatus for security managing of an information terminal according to the embodiment of the present invention further includes a hooking implementing unit that hooks a system call command requesting access to the domains from the user process and transmits the system call command to the access control unit and a storage unit that stores information on the plurality of domains including at least one information providing means.

When the user process accesses any one domain and then attempts to access another domain, the access control unit interrupts the access of the user process to said another domain. The access control unit outputs an inquiry message to verify whether or not the access of the user process to said another domain is allowed when the user process accesses any one domain and then attempts to access said another domain.

Meanwhile, the security management unit generates a domain allowance list for the user process at a user's request while the user process is executed and establishes a security policy on the basis of the domain allowance list. At this time, the access control unit allows the user process to access said another domain when the domain allowance list of the user process includes information on said another domain in the case in which the user process accesses any one domain and then attempts to access another domain.

Further, the security management unit generates a domain interruption list for the user process at the user's request while the user process is executed and establishes the security policy on the basis of the domain interruption list. At this time, the access control unit interrupts the access of the user process to said another domain when the domain interruption list of the user process includes the information on said another domain in the case in which the user process accesses any one domain and attempts to access another domain.

Meanwhile, in order to achieve the above-mentioned object, a method for security managing of an information terminal according to another embodiment of the present invention includes allowing a user process to access a requested domain among a plurality of domains including at least one information providing means at a user process request for accessing the domain; verifying whether or not, when the user process attempts to access another domain among the plurality of domains, the access of the user process to said another domain is allowed; and controlling the access of the user process to said another domain in accordance with a verification result in the verification step.

In verifying whether or not the access is allowed, the access of the user process to said another domain is interrupted when the user process accesses any one domain and then attempts to access another domain. Meanwhile, verifying whether or not the access is allowed includes outputting an inquiry message to verify whether or not the access of the user process to said another domain is allowed.

Meanwhile, the method for security managing of an information terminal according to the embodiment of the present invention further includes generating a domain allowance list for the user process at a user's request while the user process is executed. At this time, verifying whether or not the access is allowed further includes verifying the domain allowance list of the user process and the access of the user process to said another domain is allowed when the domain allowance list of the user process includes information on said another domain.

Further, the method further includes generating a domain interruption list for the user process for the user's request while the user process is executed. At this time, verifying whether or not the access is allowed further includes verifying the domain interruption list of the user process, and the access of the user process to said another domain is interrupted when the domain interruption list of the user process includes the information on said another domain.

Further, in order to achieve the above-mentioned object, the present invention provides a processor-readable recording medium in which a program for executing a control method of an external interface of an information terminal according to the present invention is recorded.

According to the present invention, security threats are monitored for each domain which an execution process accesses by simply constructing domain classification information of an entire system without specifically establishing a security policy of an information providing means, such that it is possible to protect a terminal from a multi-domain access process having high security risk. Accordingly, it is advantageous to increase security for the terminal from various security threats.

### BRIEF DESCRIPTION OF THE DRAWINGS

FIG. 1 is a configuration diagram for illustrating a configuration of an apparatus for security managing of an information terminal according to an embodiment of the present invention;

FIGS. 2 and 3 are exemplary diagrams for illustrating an operation of an apparatus for security managing of an information terminal according to an embodiment of the present invention; and

FIGS. 4 to 5 are flowcharts illustrating an operation flow of a method for security managing of an information terminal according to an embodiment of the present invention.

### DETAILED DESCRIPTION OF THE PREFERRED EMBODIMENTS

Hereinafter, embodiments of the present invention will be described with reference to the accompanying drawings.

First, the present invention discloses a technique to maximize security of an apparatus for security managing of an information terminal by effectively controlling access of subjects such as a user, a process, a service, etc. to information objects such as a file, a network remote page, etc. at an operating system level or a kernel level in order to enforce security of an information providing means. In particular, the present invention discloses a measure to cope with an access control situation in real time by providing an ‘object domain separation control technique’ that can effectively prevent information leakage or infringement without security administrator's minute static establishment unlike the existing scheme.

Herein, the ‘object domain separation control technique’ classifies information objects that access the information providing means into a plurality of domains in accordance with a utilization intention, a property, and a security level and controls movement of information between different domains. That is, when one execution process attempts access to the plurality of domains at the same time, it is determined as the security threat situation and the access attempt is reported to the user to allow or interrupt access to the corresponding domain.

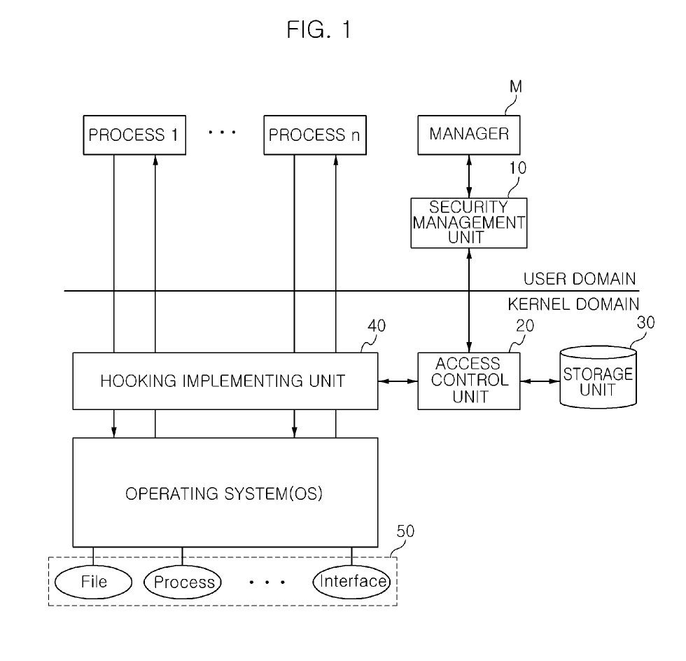

Therefore, referring to FIG. 1, a configuration of an information security system for an information providing means according to the present invention will be described in more detail. FIG. 1 is a diagram for illustrating the configuration of the information providing means according to the present invention. Herein, the information providing means according to the present invention includes all information processing terminals such as a PC, a notebook, a UMPC, a PDA, a PMP, a smart phone, a wibro terminal, a telematics terminal, etc.

Referring to FIG. 1, the information providing means according to the present invention will be described by largely dividing a user domain (A) and a kernel domain (B).

First, the user domain (A) is a domain which can generally be controlled by the user and represents a domain where a process corresponding a user's control command is called. Meanwhile, the kernel domain (B), as a domain where the called process is implemented, includes an operating system (OS). Herein, the operating system controls access of subjects such as a user, a process, a service, etc. to an information providing means 50 such as a file, an interface, a resource, etc. At this time, a hardware device of an information security terminal is connected to its peripheral devices, such that the operating system connects the corresponding hardware devices at the request of an execution process.

The information providing means according to the present invention includes a security management unit 10, an access control unit 20, and a storage unit 30. First, the security management unit 10 classifies a plurality of information providing means 50 into domains including at least one information providing means 50 at a user request. At this time, the domains are classified on the basis of attributes, security levels, etc. of the plurality of information providing means 50 and the classification criterion is changeable by the user. Further, the security management unit 10 generates a security policy for each domain. At this time, the security management unit 10 can generate a domain allowance list for a domain interruption list with respect to a user process executed at the user request and reestablishes the security policy by using the generated allowance list and the domain interruption list.

Meanwhile, the security management unit 10 can establish whether a system call is interrupted without delay or the system call is interrupted after inquiring of the user in the case of a security threat situation against a case in which even a normal process is recognized as the security threat situation. Herein, the security management unit 10 can be implemented in the user domain (A) and the kernel domain (B).

The storage unit 30 stores a domain classification rule in accordance with access of the user process to a kernel and stores information of a plurality of domains classified by the domain classification rule. Further, the storage unit 30 stores a domain allowance established with respect to a predetermined process. Meanwhile, the storage unit 30 may store a domain interruption list established with respect to a predetermined process. At this time, the storage unit 30 provides the stored information at the request of the security management unit 10 or the access control unit 20.

The access control unit 20 controls access of the user process of the plurality of domains on the basis of the information on the plurality of domains stored in the storage unit 30.

Herein, the access control unit 20 allows one user process which is being executed to access only one domain. That is, when the user process which is being executed attempts to access another domain after accessing any one domain among the plurality of domains, the access control unit 20 recognizes the case as the security threat situation and interrupts the access of the corresponding user process to another domain.

Further, when the user process attempts to access information providing means 50 such as a local file, an IP network through Ethernet, a USB, etc. at the same time, the information providing means 50 correspond to different domains, such that the access control unit 20 interrupts access of the corresponding user process to the plurality of domains by recognizing the case as the security threat situation.

In the case when one execution process being executed attempts to access another domain after accessing one domain or attempts to access the plurality of domains at the same time while one execution process is executed, the security threat situation includes all situations in which a probability that infringement or leakage such as movement, copy, damage, etc. will occur with respect to information included in different domains is expected to be high.

Of course, even a normal process in which no malicious code is included in the execution process may be determined as a dangerous security situation that requires monitoring the operating system. In this case, even though information is damaged by malicious codes when the execution process accesses only any one domain, an infringement domain is limited to the corresponding domain, whereby an entire system of the information terminal can be safely protected.

Meanwhile, the access control unit 20 may allow the user process being executed to access the plurality of domains (hereinafter, referred to as ‘multi-domain access’) in accordance with the security management unit 10′s establishment in the case of the security threat situation. For example, since a document work is performed through a document editor, the user process may attempt to access a network domain in order to access a web page inputted by the user while accessing a local drive. At this time, the access control unit 20 establishes a rule that takes precedence over the pre-established domain access policy with respect to a reliable application. Only in this case, the multi-domain access may exceptionally be allowed.

Further, when the user process being executed attempts the multi-domain access, the access control unit 20 reports it to the security management unit 10. At this time, the security management unit 10 outputs an inquiry message of inquiring whether or not access to the corresponding domain of the user is allowed and applies a response signal of the user to the inquiry message to the access control unit 20. Accordingly, the access control unit 20 may allow the corresponding user process to temporarily or continuously access multi-domains depending on a user's response.

Whenever the user process attempts the multi-domain access, the access control unit 20 provides access information of the corresponding user process to the security management unit 10 in real time. At this time, the security management unit 10 outputs the access information of the user process to the outside. Further, the security management unit 10 provides access allowance information inputted by the user to the access control unit 20 in real time, such that the access control unit 20 applies the inputted access allowance information in real time to control the multi-domain access of the corresponding user process.

At this time, the security management unit 10 generates the domain allowance list and adds the corresponding domain information to the domain allowance list of the user process depending on the user's response. As a result, when the user process being executed attempts the multi-domain access, the access control unit 20 can also allow the user process to access a domain included in the domain allowance list at all times.

Meanwhile, the security management unit 10 generates the domain interruption list and adds the corresponding domain information to the domain interruption list of the user process depending on the user's response. Therefore, when the user process being executed attempts the multi-domain access, the access control unit 20 can also interrupt access to a domain included in the domain interruption list at all times.

Herein, the domain allowance list and the domain interruption list are initialized when execution of the corresponding user process is terminated and re-established when a next process is executed.

Meanwhile, the information providing means further includes a hooking implementing unit 40 that hooks a system call command to request domain access from the user process and transmits the system call command to the access control unit 20. At this time, the hooking implementing unit 40 transmits a control command of the access control unit 20 for the hooked system call command to the operating system.

Therefore, the access control unit 20 verifies the access domain of the corresponding user process from the system call command hooked through the hooking implementing unit 40. At this time, the access control unit 20 verifies whether or not the domain access of the corresponding user process is initial access and gives a control command to allow or interrupt access of the user process to the corresponding domain. At this time, the hooking implementing unit 40 transmits the control command of the access control unit 20 to the operating system to allow the operating system to execute the control command of the access control unit 20.

An access control logic which can be implemented in the security management device of the information terminal may perform a corresponding function while being inserted into the operating system. For example, a Linux operating system can hook the system call through a Linux security module (LSM). Accordingly, an application program may perform, allow, or reject an additional operation by intercepting a call of a system that accesses information objects such as the file, the network, etc. by inserting the access control logic into the LSM.

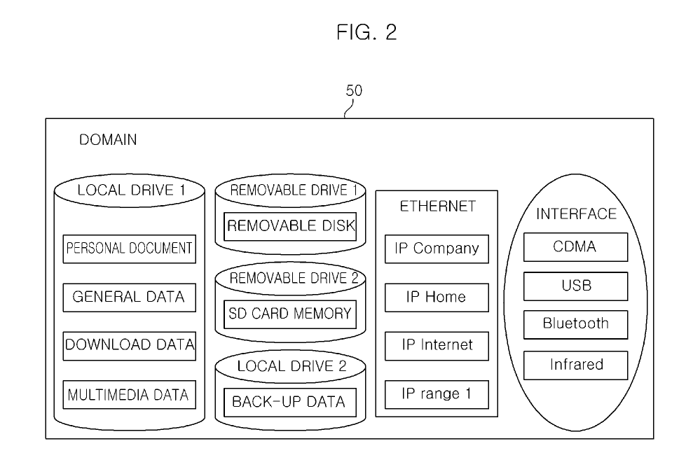

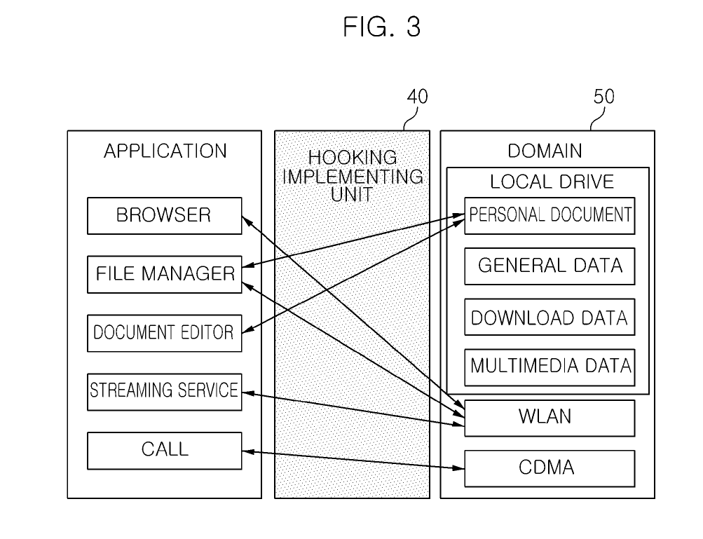

FIGS. 2 and 3 are exemplary diagrams for illustrating an operation of an apparatus for security managing of an information terminal according to an embodiment of the present invention.

First, FIG. 2 illustrates an embodiment in which domains are classified by the apparatus for security managing of an information terminal according to the present invention.

Referring to FIG. 2, a ‘local drive 1’ including a personal document, general data, download data, multimedia data, etc. is classified as a first domain, a ‘removable drive 1’ including a removable disk is classified as a second domain, a ‘removable drive 2’ including an SD card memory is classified as a third domain, a ‘local drive 2’ including back-up data is classified as a fourth domain, ‘Ethernet’ including IP Company, IP Home, IP Internet, IP range 1, etc. is classified as a fifth domain, and an ‘interface’ including CDMA, USB, Bluetooth, Infrared, etc. is classified as a sixth domain.

The plurality of domains are classified on the basis of attributes, security levels, etc. of the plurality of information providing means 50 and the criterion is changeable by the user. Further, the security management unit 10 generates the domain allowance list or the domain interruption list with respect to the user process executed at the user request to thereby allow or interrupt the access of the user process to the corresponding domain.

FIG. 3 illustrates one embodiment in which a plurality of applications access the classified domains, respectively, as shown in FIG. 2. In the case of the application shown in FIG. 3, a browser, each of a document editor, a streaming service, and a call service except for a file manager accesses the ‘personal document’ of the first domain and the ‘WLAN’ and ‘CDMA’ of the sixth domain.

At this time, the hooking implementing unit 40 hooks a system call between the application and the domain and transmits the system call to the access control unit 20. At this time, the access control unit 20 allows or interrupts access of the corresponding application to the domain by the system call. In this case, since one application accesses one domain, the access control unit 20 regards this state not as the security threat situation.

Meanwhile, the file manager attempts to access the ‘personal document’ of the first domain and the ‘WLAN’ of the sixth domain. The access control unit 20 recognizes this case as the security threat situation and thus interrupts access of the file manager to the multi-domains. At this time, when the file manager already accesses the ‘personal document’ of the first domain, the access control unit interrupts the access to the ‘WLAN’ of the sixth domain and vice versa. Of course, the access control unit 20 may inquire of the user or when the first domain information and the sixth domain information are registered in the domain allowance list with respect to the file manger, the access control unit 20 may allow the file manager to access both the first domain and the sixth domain.

The above-configured operation of the present invention will now be described.

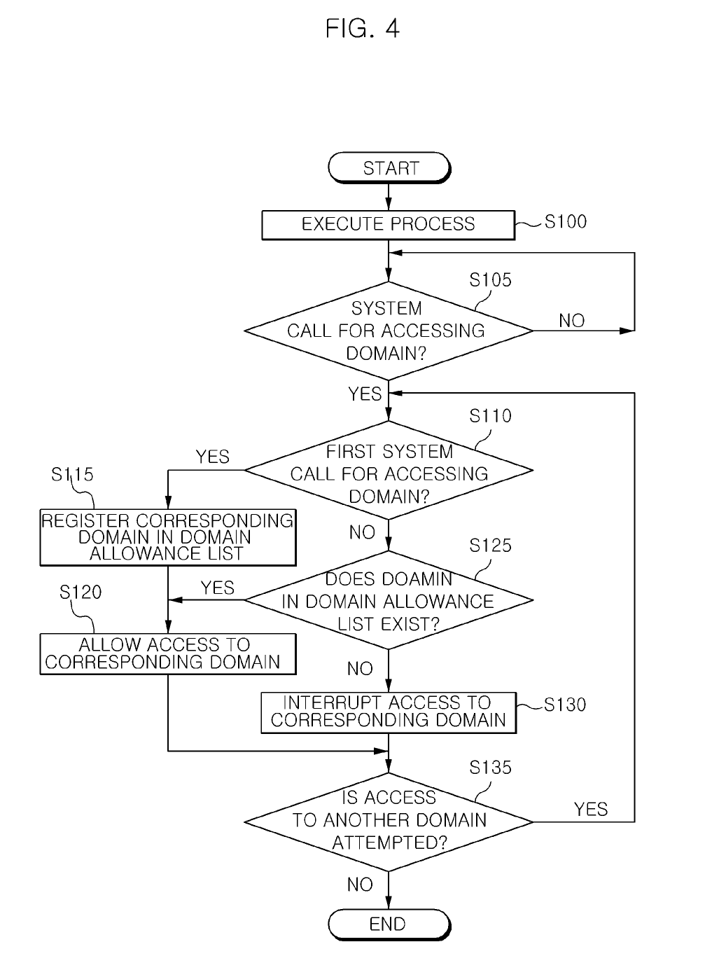

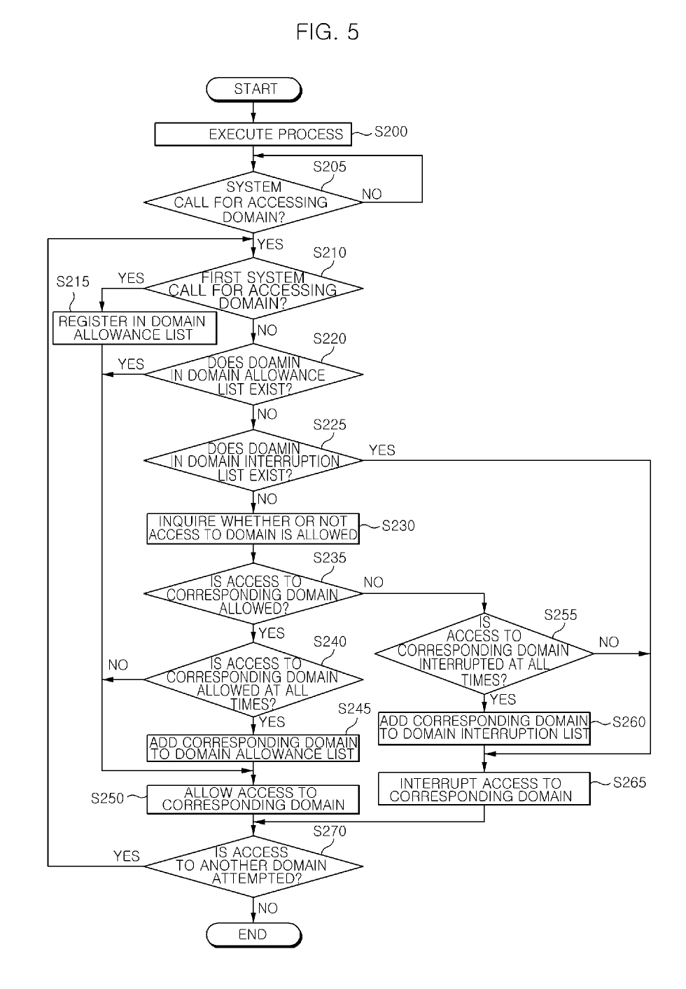

FIGS. 4 to 5 are flowcharts illustrating an operation flow of a method for security managing of an information terminal according to an embodiment of the present invention.

First, FIG. 4 illustrates an operation flow with respect to a method for security managing of an information terminal according to a first embodiment of the present invention and illustrates a case in which an execution process accesses an initially accessed domain.

Referring to FIG. 4, a process selected at a user's request is executed (S100) and in this case, while the process is executed, the corresponding process attempts to access a kernel domain by applying a system call to request the access to the domain (S105). At this time, a hooking implementing unit 40 hooks the system call to request the access to the domain and applies the hooked system call to an access control unit 20.

The access control unit 20 verifies whether or not the system call is a first system call for access of the corresponding process to the domain from a system call command (S110). If the system call is the first system call for accessing the domain while the corresponding process is executed, information on the corresponding domain is applied to the security management unit 10 and then the security management unit 10 registers the corresponding domain information in a domain allowance list (S115). Therefore, the access control unit 20 allows the process to access the corresponding domain on the basis of the first system call (S120).

On the contrary, if the corresponding system call command is not the first system call for accessing the domain, the access control unit 20 detects the corresponding domain information and verifies whether or not the detected domain information is provided in the domain allowance list of the corresponding process (S125).

If the detected domain information is provided in the domain allowance list of the corresponding process, the access control unit 20 allows the process to access the corresponding domain (S120). On the contrary, if the detected domain information is not provided in the domain allowance list of the corresponding process, the access control unit 20 interrupts the access of the process to the corresponding domain (S130).

Meanwhile, when a system call for attempting to access another domain is generated while the corresponding process is executed (S135), the access control unit 20 interrupts access to domains other than the firstly accessed domain while the process is executed by repetitively steps ‘S110’ to ‘S130’.

FIG. 5 illustrates an operation flow with respect to a method for security managing of an information terminal according to a second embodiment of the present invention and illustrates a case in which an execution which is allowed to access a predetermined domain is allowed to access multi-domains.

Referring to FIG. 5, a process selected at a user's request is executed (S200) and in this case, while the process is executed, the corresponding process attempts to access a kernel domain by applying a system call to request the access to the domain (S205). At this time, a hooking implementing unit 40 hooks the system call to request the access to the domain and applies the hooked system call to an access control unit 20.

The access control unit 20 verifies whether or not the system call is an initial system call for access of the corresponding process to the domain from a system call command (S210). If the system call is the first system call for accessing the domain while the corresponding process is executed, information on the corresponding domain is applied to the security management unit 10 and then the security management unit 10 registers the corresponding domain information in a domain allowance list (S215). Therefore, the access control unit 20 allows the process to access the corresponding domain on the basis of the first system call (S250).

On the contrary, if the corresponding system call command is not the first system call for accessing the domain, the access control unit 20 detects the corresponding domain information and verifies whether or not the detected domain information is provided in the domain allowance list of the corresponding process (S220). If the detected domain information is provided in the domain allowance list of the corresponding process, the access control unit 20 allows the process to access the corresponding domain (S250).

On the contrary, if the detected domain information is not provided in the domain allowance list of the corresponding process, the access control unit 20 verifies whether or not the detected domain information is provided in a domain interruption list of the corresponding process (S225). If the detected domain information is provided in the domain interruption list of the corresponding process, the access control unit 20 interrupts the access of the process to the corresponding domain (S265).

On the contrary, if the detected domain information is not provided in the domain interruption list of the corresponding process, the access control unit 20 generates and outputs an inquiry message to verify whether or not the access to the corresponding domain is allowed. At this time, the outputted inquiry message is outputted to a user through the security management unit.

At this time, when a response to allow the access to the corresponding domain is inputted from the user, the access control unit 20 verifies whether or not the access to the corresponding domain is allowed at all times while the process is executed (S240). If the access to the corresponding domain is not allowed at all times, the access control unit 20 instantly allows the process to access the corresponding domain (S250). On the contrary, if the access to the corresponding domain is allowed, information on the corresponding domain is applied to the security management unit 10 to be added to the domain allowance list by the security management unit 10 (S245). Thereafter, the access control unit 20 allows the process to access the corresponding domain (S250).

Meanwhile, when a response to reject the access to the corresponding domain is inputted from the user, the access control unit 20 verifies whether or not the access to the corresponding domain is interrupted at all times while the process is executed (S255). If the access to the corresponding domain is not interrupted at all times, the access control unit 20 instantly interrupts the process to access the corresponding domain (S265). On the contrary, if the access to the corresponding domain is interrupted at all times, the information on the corresponding domain is applied to the security management unit 10 to be added to the domain interruption list by the security management unit 10 (S260). Thereafter, the access control unit 20 interrupts the access of the process to the corresponding domain (S265).

Further, when a system call for attempting to access another domain is generated from the corresponding process while the corresponding process is executed (S270), the access control unit 20 allows access to only a domain registered in the domain allowance list and interrupts access to domains other than the registered domain while the process is executed by repetitively steps ‘S210’ to ‘S265’.

As described above, in an apparatus and a method for security managing of an information terminal according to the present invention, the configuration and method of the embodiments described as above can limitatively not be adopted, but the embodiments may be configured by selectively combining all the embodiments or some of the embodiments so that various modifications can be made.

Meanwhile, the present invention can be implemented as a processor-readable code in a processor-readable recording medium which is provided in an information terminal. The processor-readable recording medium includes all types of recording devices which can store data readable by a processor. Examples of the processor-readable recording medium include a ROM, a RAM, a CD-ROM, a magnetic tape, a floppy disk, an optical data storage, etc. and further include a device which is implemented in the form of a carrier wave such as transmission through Internet. Moreover, the processor-readable recording medium is distributed in a computer system connected through a network and the processor-readable code can be stored and executed by a distribution scheme.

Although preferred embodiments of the present invention have been illustrated and described, the present invention is not limited to the above-mentioned embodiments and various modifications can be made by those skilled in the art without the scope of the appended claims of the present invention. In addition, these modified embodiments should not be appreciated separately from technical spirits or prospects.

What is claimed is:

1. An apparatus for security managing of an information terminal which can be connected with a plurality of information providing means, comprising:
a security management unit that establishes security policies for domains on information in which the plurality of information providing means are classified into the domains including at least one information providing means; and
an access control unit that when a user process accesses any one domain and then attempts to access another domain, controls the access of said another domain by verifying whether or not the access of the user process to said another domain in accordance with a security policy generated by the security management unit.

2. The apparatus for security managing of an information terminal according to claim 1, further comprising:
a hooking implementing unit that hooks a system call command requesting access to the domains from the user process and transmits the system call command to the access control unit.

3. The apparatus for security managing of an information terminal according to claim 1, wherein when the user process accesses any one domain and then attempts to access another domain, the access control unit interrupts the access of the user process to said another domain.

4. The apparatus for security managing of an information terminal according to claim 1, wherein the access control unit outputs an inquiry message to verify whether or not the access of the user process to said another domain is allowed when the user process accesses any one domain and then attempts to access said another domain.

5. The apparatus for security managing of an information terminal according to claim 1, wherein the security management unit generates a domain allowance list for the user process and establishes a security policy on the basis of the domain allowance list.

6. The apparatus for security managing of an information terminal according to claim 5, wherein the access control unit allows the user process to access said another domain when the domain allowance list of the user process includes information on said another domain in the case in which the user process accesses any one domain and then attempts to access another domain.

7. The apparatus for security managing of an information terminal according to claim 1, wherein the security management unit generates a domain interruption list for the user process and establishes the security policy on the basis of the domain interruption list.

8. The apparatus for security managing of an information terminal according to claim 7, wherein the access control unit interrupts the access of the user process to said another domain when the domain interruption list of the user process includes the information on said another domain in the case in which the user process accesses any one domain and attempts to access another domain.

9. The apparatus for security managing of an information terminal according to claim 1, further comprising:
a storage unit that stores information on the plurality of domains including at least one information providing means.

10. A method for security managing of an information terminal which can be connected to a plurality of information providing means, comprising:
allowing a user process to access a requested domain among a plurality of domains including at least one information providing means at a user process' request for accessing the domain;
verifying whether or not, when the user process attempts to access another domain among the plurality of domains, the access of the user process to said another domain is allowed; and
controlling the access of the user process to said another domain in accordance with a verification result in the verification step.

11. The method for security managing of an information terminal according to claim 10, further comprising:
before allowing the user process to access the requested domain, classifying the plurality of information providing means into domains including at least one information providing means; and
generating a security policy for each of the classified domains.

12. The method for security managing of an information terminal according to claim 10, wherein in verifying whether or not the access is allowed, the access of the user process to said another domain is interrupted when the user process accesses any one domain and then attempts to access another domain.

13. The method for security managing of an information terminal according to claim 10, wherein verifying whether or not the access is allowed includes outputting an inquiry message to verify whether or not the access of the user process to said another domain is allowed.

14. The method for security managing of an information terminal according to claim 10, further comprising:
generating a domain allowance list for the user process.

15. The method for security managing of an information terminal according to claim 14, wherein verifying whether or not the access is allowed further includes verifying the domain allowance list of the user process, and
wherein the access of the user process to said another domain is allowed when the domain allowance list of the user process includes information on said another domain.

16. The method for security managing of an information terminal according to claim 10, further comprising:
generating a domain interruption list for the user process.

17. The method for security managing of an information terminal according to claim 16, wherein verifying whether or not the access is allowed further includes verifying the domain interruption list of the user process, and
wherein the access of the user process to said another domain is interrupted when the domain interruption list of the user process includes the information on said another domain.
